(19) United States
(12) Patent Application Publication
(10) Pub. No.: US 2003/0145122 A1
(43) Pub. Date: Jul. 31, 2003

(54) Apparatus and method of allowing multiple partitions of a partitioned computer system to use a single network adapter

(75) Inventors: Dwip N. Banerjee, Austin, TX (US); Deanna Lynn Quigg Brown, Pflugerville, TX (US); Vasu Vallabhaneni, Austin, TX (US)

Correspondence Address: Mr. Volel Emile, P.O. Box 202170, Austin, TX, 78720-2170, US

(73) Assignee: International Business Machines Corporation, Armonk, NY (US)

(21) Appl. No.: 10/059,609

(22) Filed: Jan. 30, 2002

(51) Int. Cl. G06F 15/16

(52) U.S. Cl. 709/250

(57) ABSTRACT

A method, system and apparatus for allowing a single network adapter to be used by a plurality of partitions of a logically partitioned computer system (LPAR) are provided. Each partition assigns a different IP address to the network adapater. The different IP addresses are stored in a table. The table cross-references each IP address with its partition. When a piece of data is received by the computer system, the data is examined to find out the IP address associated with the data. Once done, the table is consulted to determine to which one of the plurality of partitions the data is to be forwarded. The data is then forwarded to the partition.

### BACKGROUND OF THE INVENTION

1. Technical Field

The present invention is directed to a method and apparatus for managing a computer system. More specifically, the present invention is directed to a method and apparatus for allowing multiple partitions of a computer system to use a single network adapter.

2. Description of Related Art

Presently, many computer manufacturers design computer systems with partitioning capability. To partition a computer system is to divide the computer system's resources (i.e., memory devices, processors etc.) into groups; thus, allowing for a plurality of operating systems to be concurrently executing on the computer system.

Partitioning a computer system may be done for a variety of reasons. Firstly, it may be done for consolidation purposes. Clearly consolidating a variety of computer systems into one by running multiple application programs that previously resided on the different computer systems on only one reduces (i) cost of ownership of the system, (ii) system management requirements and (iii) footprint size.

Secondly, partitioning may be done to provide production environment and test environment consistency. This, in turn, may inspire more confidence that an application program that has been tested successfully will perform as expected.

Thirdly, partitioning a computer system may provide increased hardware utilization. For example, when an application program does not scale well across large numbers of processors, running multiple instances of the program on separate smaller partitions may provide better throughput.

Fourthly, partitioning a system may provide application program isolation. When application programs are running on different partitions, they are guaranteed not to interfere with each other. Thus, in the event of a failure in one partition, the other partitions will not be affected. Furthermore, no one application program may consume an excessive amount of hardware resources. Consequently, no application programs will be starved out of required hardware resources.

Lastly, but not least, partitioning provides increased flexibility of resource allocation. A workload that has resource requirements that vary over a period of time may be managed more easily if it is being run on a partition. That is, the partition may be easily altered to meet the varying demands of the workload.

Currently, however, multiple partitions cannot use a single network adapter. This is because when an adapter receives incoming data, it will not know to which one of the different partitions to convey the data. Consequently, each partition that interacts with a network has to have its own dedicated network adapter.

But, since some network adapters may be quite expensive, it would be desirable to have a method that would allow multiple partitions to share one network adapter.

### SUMMARY OF THE INVENTION

The present invention provides a method, system and apparatus for allowing a single network adapter to be used by a plurality of partitions of a logically partitioned computer system (LPAR). Each partition assigns a different IP address to the network adapater. The different IP addresses are stored in a table. The table cross-references each IP address with its partition. When a piece of data is received by the computer system, the data is examined to find out the IP address associated with the data. Once done, the table is consulted to determine to which one of the plurality of partitions the data is to be forwarded. The data is then forwarded to the partition.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4 illustrates logical a plurality of partitions of a computer system.

FIG. 5 depicts a piece of data with an IP header and a TCP header.

FIG. 6 depicts a cross-reference table used by the invention to allow a network adapter to forward data to a partition to which the data is destined.

FIG. 7 is a flow chart of a process that may be used with the invention.

### DETAILED DESCRIPTION OF THE PREFERRED EMBODIMENT

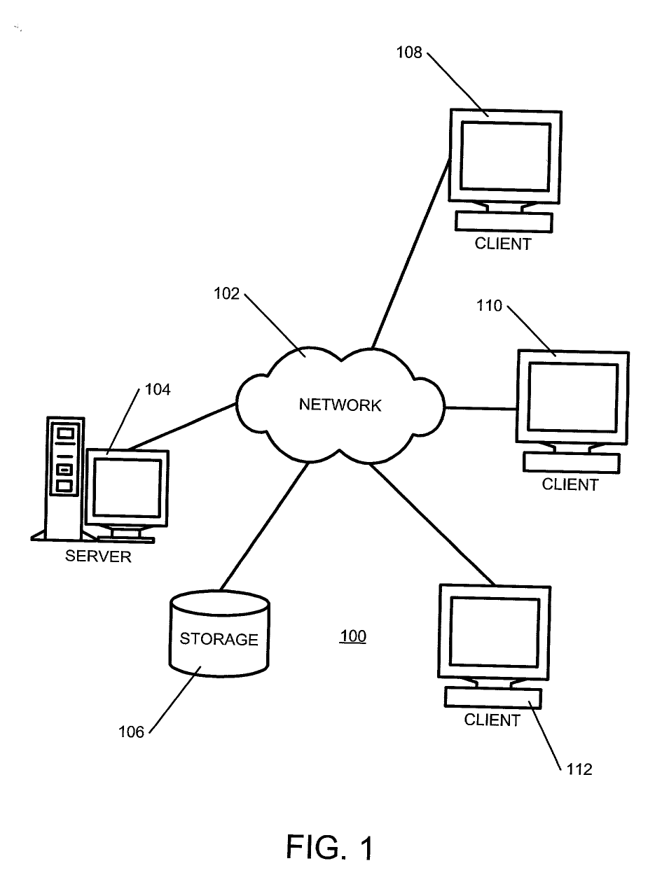

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN) . FIG. 1 is intended as an example, and not as an architectural limitation for the present invention.

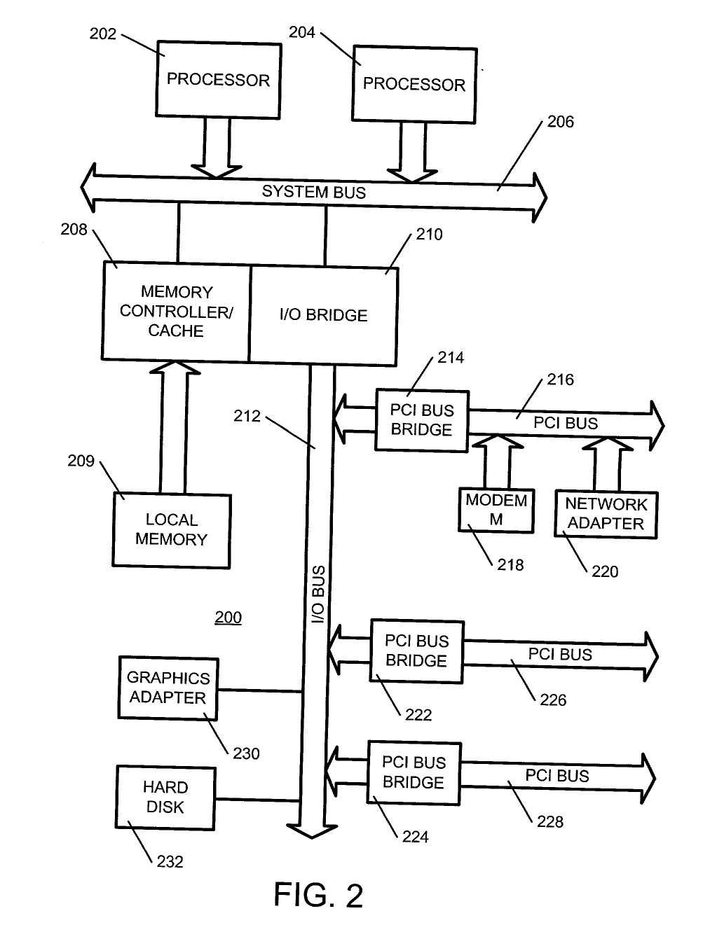

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

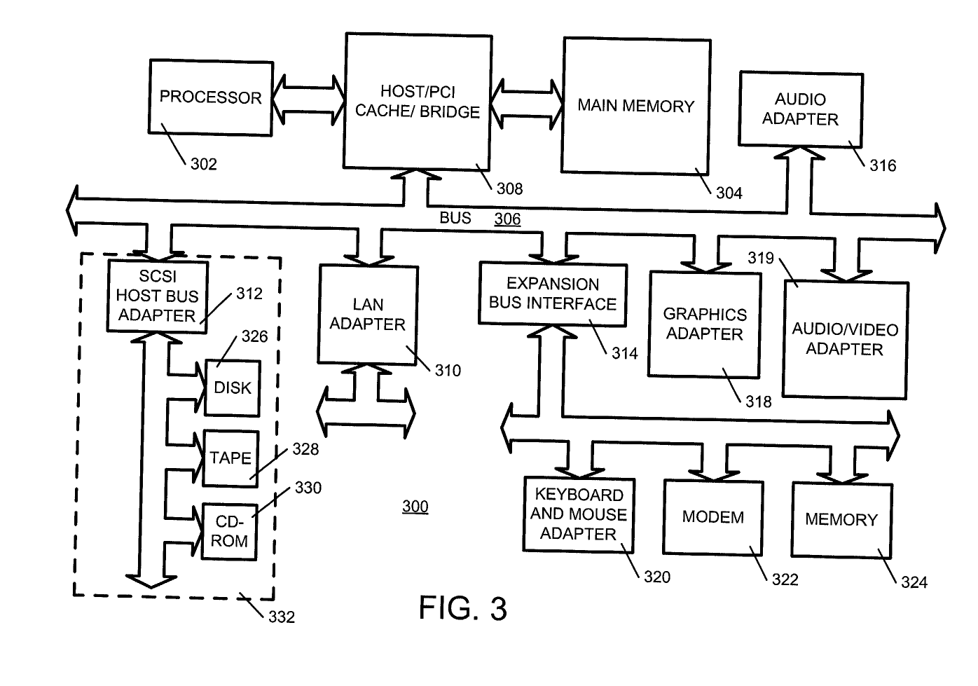

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides an apparatus and method of allowing a network adapter to be shared among a plurality of partitions of an LPAR system. The invention may be local to client systems 108, 110 and 112 of FIG. 1 or to the server 104 or to both the server 104 and clients 108, 110 and 112. Consequently, the present invention may reside on any data storage medium (i.e., floppy disk, compact disk, hard disk, ROM, RAM, etc.) used by a computer system.

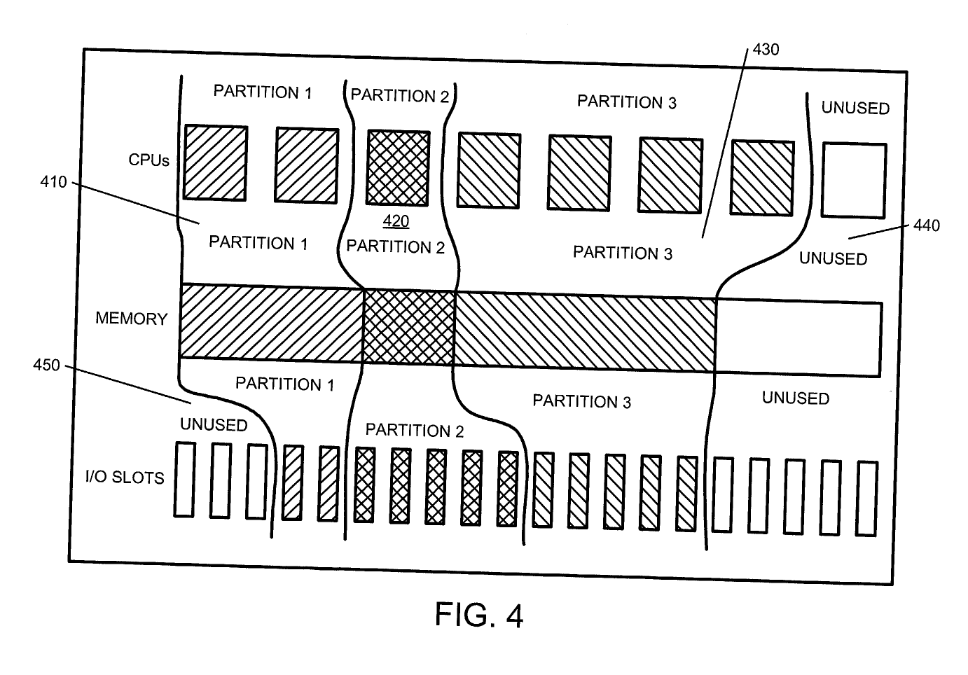

FIG. 4 illustrates logical a plurality of partitions of a computer system. Partition 1 410 has two (2) processors, two (2) I/O slots and used a percentage of the memory device. Partition 2 420 uses one (1) processor, five (5) I/O slots and also used a smaller percentage of the memory device. Partition 3 430 uses four (4) processors, five (5) I/O slots and uses a larger percentage of the memory device. Areas 440 and 450 of the computer system are not assigned to a partition and are unused. Note that in FIG. 4 only subsets of resources needed to support an operating system are shown.

As shown, when a computer system is partitioned most of its hardware resources are assigned to a partition. The hardware resources that are not assigned are not used. More specifically, a resource may either belong to a single partition or not belong to any partition at all. If the resource belongs to a partition, it is known to and is only accessible to that partition. If the resource does not belong to any partition, it is neither known to nor is accessible to any partition. Thus, if a hardware resource, such as an adapter, is assigned to a partition it may only be used by that partition. The present invention, however, allows an adapter to be used by a plurality of partitions.

Specifically, each operating system running within a partition has its own Transmission Control Protocol/Internet Protocol (TCP/IP) stack. The TCP/IP stack is made up of a TCP layer and an IP layer. When data is being transmitted out of the computer system, the data is first forwarded to the TCP layer where a TCP header is added to the data. The TCP header includes a source port number and a destination port number to identify the application programs running on the source and the destination computer systems that are involved in the data transmission. After the TCP header is added, the data is forwarded to an IP layer where an IP header is added to the data. The IP header contains the IP addresses of the source and destination computer systems.

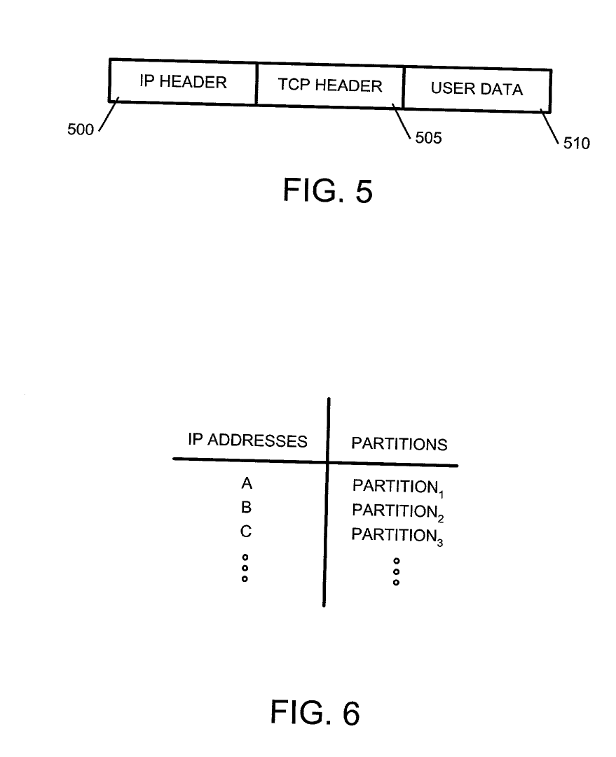

When a piece of data is received by a computer system, it is first sent to the IP layer where the IP header is stripped off the data, the data is then sent to a TCP layer where the TCP header is stripped off the data. At that point, the data is sent to the application program to which it is destined. FIG. 5 depicts a piece of data with an IP header and a TCP header.

As can be seen from the description above, a TCP/IP stack assigns an IP address to the network adapter that it uses. The invention uses a table to cross-reference an IP address assigned by a TCP/IP stack from a partition to that partition. Thus, allowing one network adapter to be used by the different partitions.

FIG. 6 depicts the cross-reference table used by the invention to allow the network adapter to forward data to a partition to which the data is destined. As alluded to above, each TCP/IP stack running on a partition will be allowed to assign an IP address to the network adapter. Each assigned IP address is entered into the table next to the partition within which the TCP/IP stack that assigns the address resides. When data is being transacted by the computer system, the table will be consulted to determine which IP address to use.

For example, when data is being transmitted out of the computer system, the IP layer in the IP stack will use an IP address according to the partition involved in the transaction. Likewise, when data is received, the IP address in the IP header of the data will be examined to determine to which partition the data is to be forwarded.

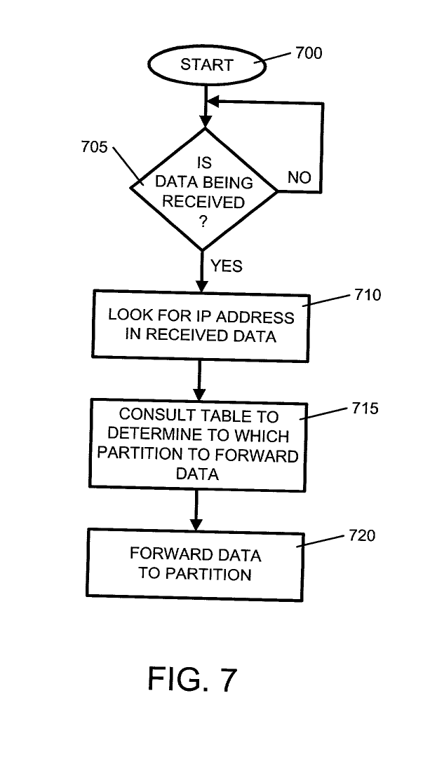

FIG. 7 is a flow chart of a process that may be used with the invention. The process starts when the computer is reset or turned on (step 700). A check is continuously being made to determine whether data is being received. If data is being received, the IP address in the data is read and compared to the IP address in the table to determine the partition to which the data is to be forwarded. Once the determination is made, the data is for a=warded to the partition (steps 705-720)

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of using one network adapter to service a plurality of partitions of an LPAR computer system comprising the steps of:
correlating each IP address with a partition;
storing the correlated IP address into a table; and
consulting the table to determine to which partition a piece of received data is to be forwarded.

2. The method of claim 1 wherein the device is reassigned to the requesting partition only if the device is currently idle.

3. The method of claim 2 wherein if the device is not idle the requesting partition is notified that the device is not idle.

4. The method of claim 2 wherein after the requesting partition has terminated using the device, it indicates so.

5. The method of claim 4 wherein upon indication that the requesting device has terminated using the device, the device is reassigned to the partition it was originally assigned.

6. A computer program product on a computer readable medium for allowing a device to be shared among partitions of a logically partitioned system comprising:
code means for determining whether a requesting partition has permission to use a device, said device not having been originally assigned to the requesting partition; and
code means for automatically reassigning the device to the requesting partition if the requesting partition has permission to use the device.

7. The computer program product of claim 6 wherein the device is reassigned to the requesting partition only if the device is currently idle.

8. The computer program product of claim 7 wherein if the device is not idle the requesting partition is notified that the device is not idle.

9. The computer program product of claim 7 wherein after the requesting partition has terminated using the device, it indicates so.

10. The computer program product of claim 9 wherein upon indication that the requesting device has terminated using the device, the device is reassigned to the partition it was originally assigned.

11. An apparatus for allowing a device to be shared among partitions of a logically partitioned system comprising:
means for determining whether a requesting partition has permission to use a device, said device not having been originally assigned to the requesting partition; and
means for automatically reassigning the device to the requesting partition if the requesting partition has permission to use the device.

12. The apparatus of claim 11 wherein the device is reassigned to the requesting partition only if the device is currently idle.

13. The apparatus of claim 12 wherein if the device is not idle the requesting partition is notified that the device is not idle.

14. The apparatus of claim 12 wherein after the requesting partition has terminated using the device, it indicates so.

15. The apparatus of claim 14 wherein upon indication that the requesting device has terminated using the device, the device is reassigned to the partition it was originally assigned.

16. A computer system for allowing a device to be shared among partitions of a logically partitioned system comprising:
at least one memory device for storing code data; and
at least one processor for processing the code data to determine whether a requesting partition has permission to use a device, said device not having been originally assigned to the requesting partition, and to automatically reassign the device to the requesting partition if the requesting partition has permission to use the device.

17. The computer system of claim 16 wherein the device is reassigned to the requesting partition only if the device is currently idle.

18. The computer system of claim 17 wherein if the device is not idle the requesting partition is notified that the device is not idle.

19. The computer system of claim 17 wherein after the requesting partition has terminated using the device, it indicates so.

20. The computer system of claim 19 wherein upon indication that the requesting device has terminated using the device, the device is reassigned to the partition it was originally assigned.
